(19) United States
(12) Patent Application Publication
(10) Pub. No.: US 2014/0233218 A1
(43) Pub. Date: Aug. 21, 2014

(54) TRANSPARENT LCD WINDOW FRAME WITH ADJUSTABLE LED SPOT LIGHTS

(71) Applicant: ALFONSO FABIAN DE LA FUENTE SANCHEZ, VICTORIA (CA)

(72) Inventor: ALFONSO FABIAN DE LA FUENTE SANCHEZ, VICTORIA (CA)

(73) Assignee: HOLOGRAFYX CANADA INC., VICTORIA (CA)

(21) Appl. No.: 14/261,391

(22) Filed: Apr. 24, 2014

(51) Int. Cl. G02F 1/1335

(52) U.S. Cl. CPC G02F 1/133615
USPC 362/97.3

(57) ABSTRACT

This invention provides a Transparent LCD window frame with adjustable LED spot lights to be primarily use as an information screen when set in front of an object. The transparent LCD displays information, images or videos in front of objects or people that are properly lighted by the built in adjustable spot LED lights. The unit is self contained and operates independent or it can be controlled externally or remotely.

### FIELD

Monitor Display units

### BACKGROUND

Traditional flat panel monitor use LCD technology to display images, information or videos that the human eye can see. These monitors are basically made out of a front open cell, some filters, a backlight and a frame. The open cell glass is a glass that has a grid where Liquid Crystal pixels are exited by variable electrical current, by powering on each pixel an image or letter is created in the screen, by combining the basic colors, red, green and blue, the displayed image becomes color and not just black and white. This process is semi invisible to the naked eye, as there's a need to filter the infrared and ultraviolet rays in order to see some of the brighted Liquid Crystals.

The open cell glass by nature is clear, but the filters are dark, if we hold an operational open cell glass to the sunlight, without any filters we could see some blurs of images, if we added the filters, the images become clearer, but the sunlight is a very powerful light source.

Our idea is to be able to have a glass window displaying information in front of an object

Our solution includes an open cell glass with lighter filters, making the open cell images visible to the naked eye. To accomplish the complete see-through viewing experience, there's the need to illuminate the object behind the window, but since there's different setup positions for the transparent LCD window in relation with the object behind the window, those lights need to be adjustable.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1, is a front view of the Transparent LCD window frame with adjustable spot LED lights

FIG. 2 is a back view of the Transparent LCD window frame with adjustable spot LED lights.

FIG. 3 is back perspective view of the Transparent LCD window frame with adjustable spot LED lights.

FIG. 4 is a front view of the rear bezel assembly.

FIG. 4a is a back view of the rear bezel assembly.

FIG. 5 is an exploded side perspective view of the Transparent LCD window frame with adjustable spot LED lights.

FIG. 6 is a top view of the Transparent LCD window frame with adjustable spot LED lights in a horizontal position with the adjustable LED spot lights fully directed to the front illuminating an object.

FIG. 7 is a top view of the Transparent LCD window frame with adjustable spot LED lights in a horizontal position with the adjustable LED spot lights rotated 45 degrees to the inside illuminating an object.

FIG. 8 is a front view of the transparent LCD window with adjustable spot LED lights with an object shown behind the window.

### DETAILED DESCRIPTION

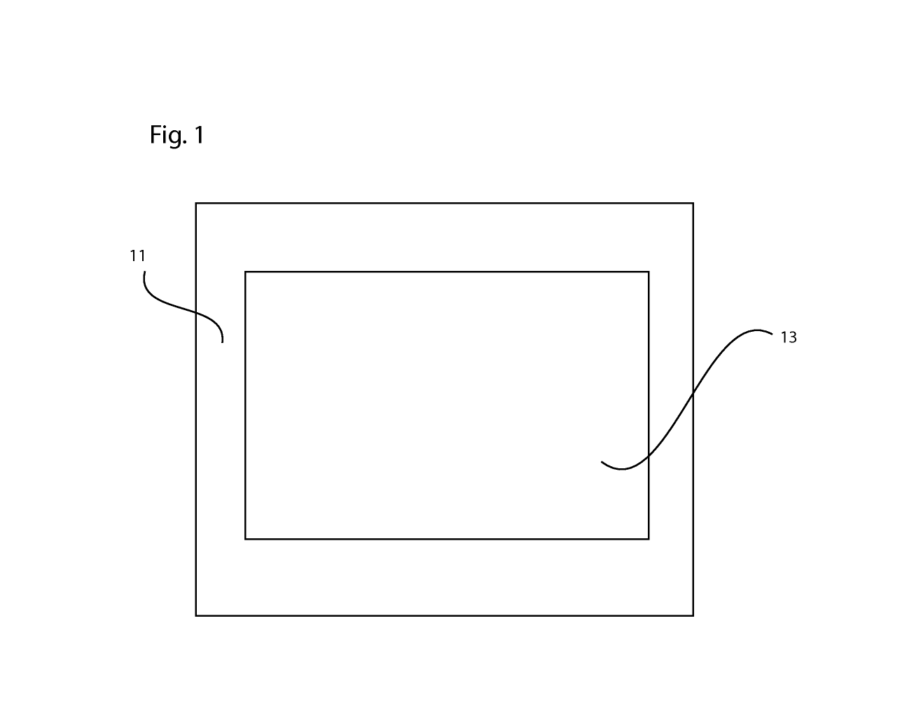

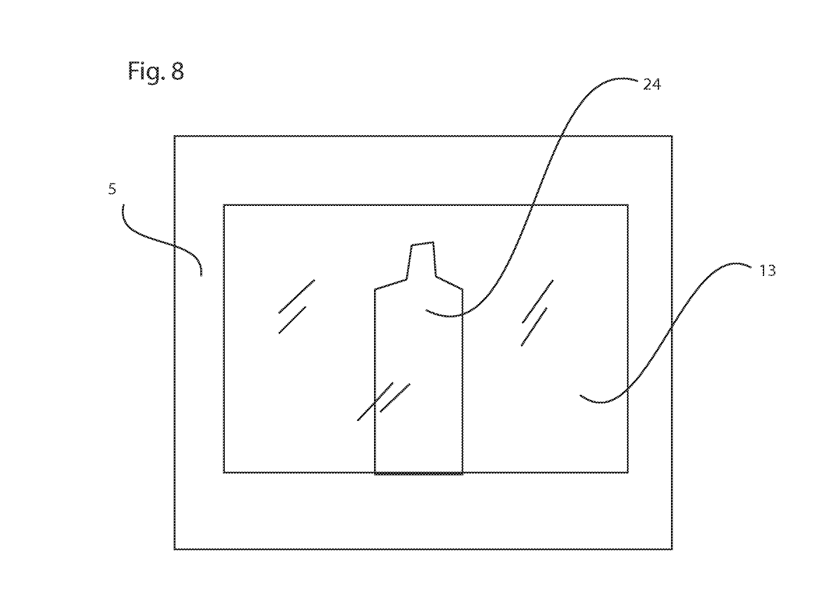

A transparent LCD window with adjustable spot LED lights generally identified by reference numeral (5) will now be described with reference to FIG. 1 through 8.

### Structure and Relationship of Parts:

Referring to FIG. 1, a front bezel (11) made of a solid material supports a transparent LCD panel (13) which acts as a transparent LCD monitor displaying information, images or videos.

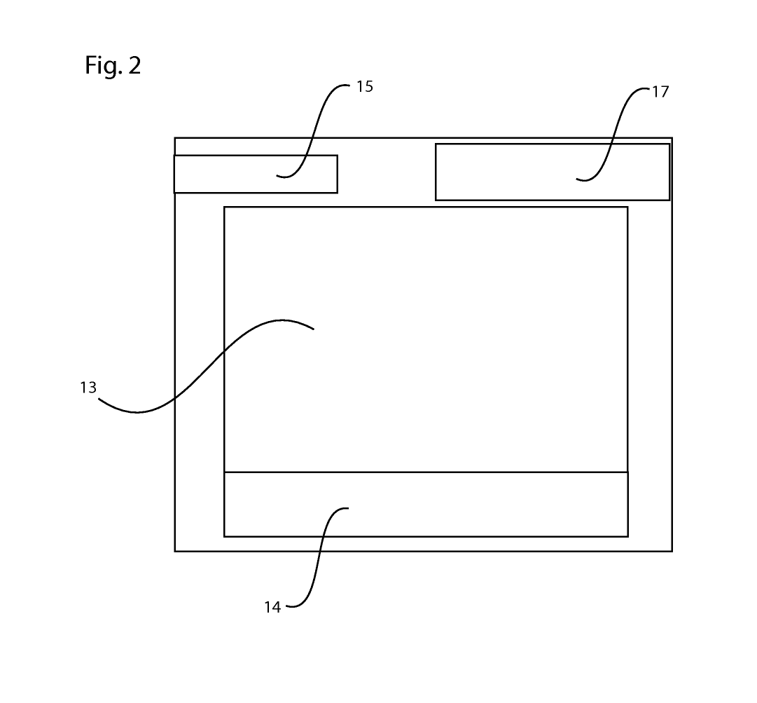

Referring to FIG. 2, the back of the front bezel (11) supports the transparent LCD (13), the transparent LCD panel control board (14) that converts the information sent by the monitor control board (15) to the transparent LCD screen (13). A power supply unit (17) feeds DC voltage to the monitor control board (15) and the transparent LCD screen (13) via the transparent LCD control board (14)

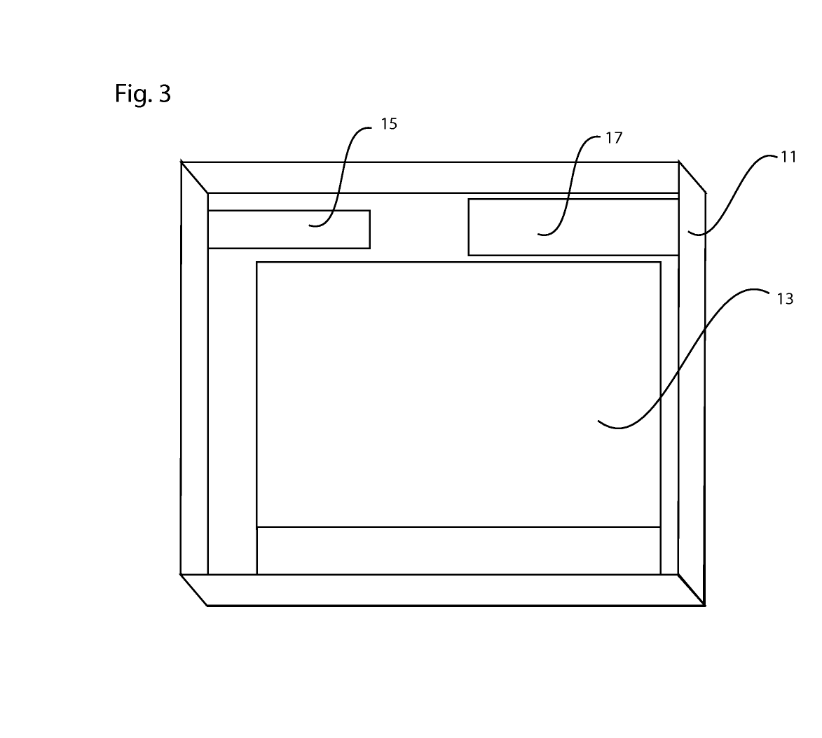

Referring to FIG. 3, the front bezel (11) acts as a chassis for the whole assembly.

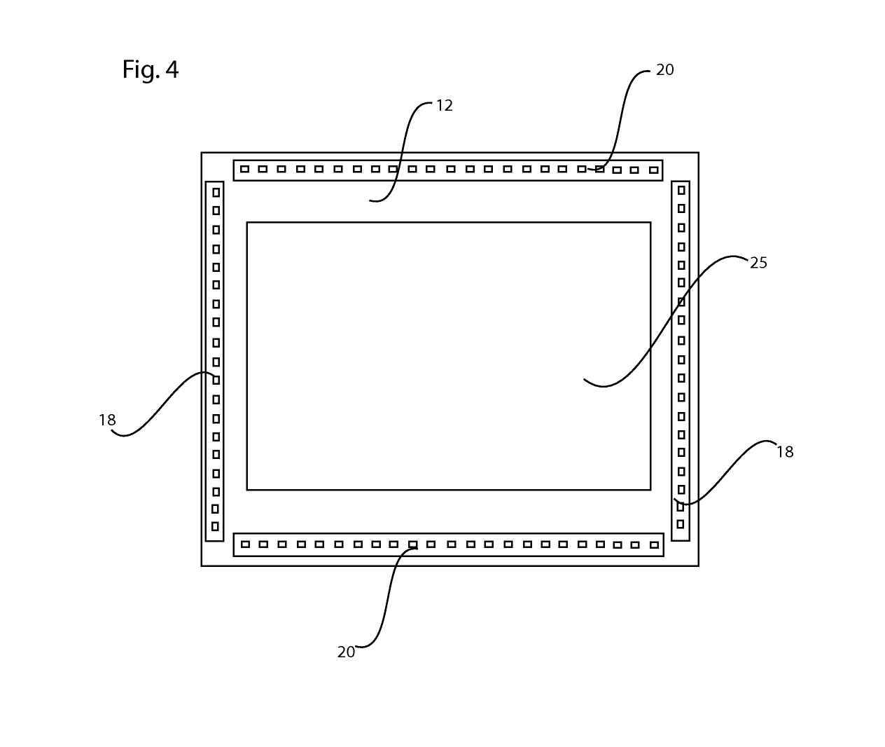

Referring to FIG. 4, the rear bezel (12) made of a solid material that fits into the back of the front bezel (11) and has a cavity (25) to allow the transparent LCD (13) to have a clearance. In one or more sides lengthwise it has an adjustable LED panels (18, 20)

Referring to FIG. 4a, the back of the rear bezel (12) has a bridge connector (26) that connects the bridge harness cable (27) to control the built in LED Panels (18, 20) from the monitor controller board (15).

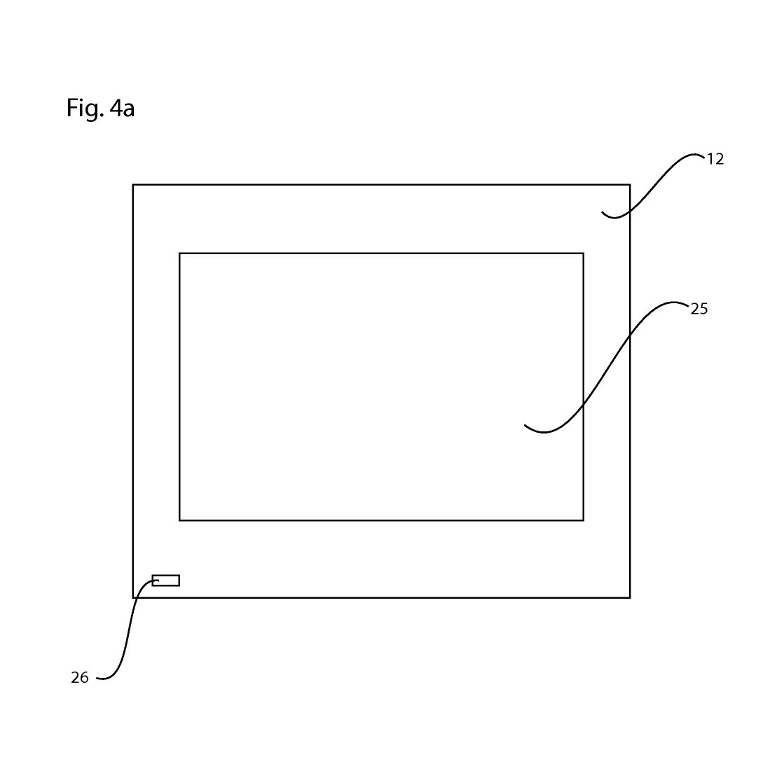

Referring to FIG. 5, an exploded perspective view of the front bezel assembly (3) and the rear bezel assembly (4) connected by the bridge harness (27) connectors (28, 29)

### Operation

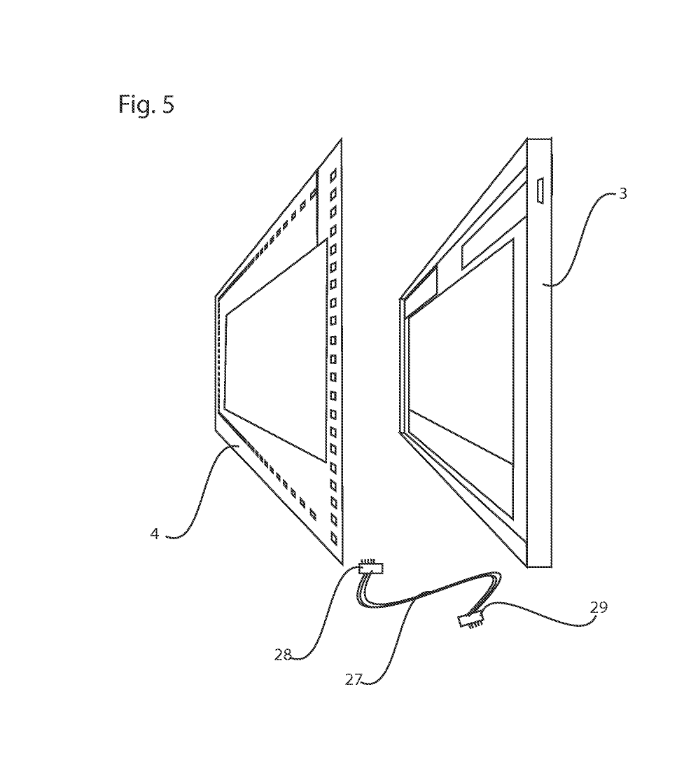

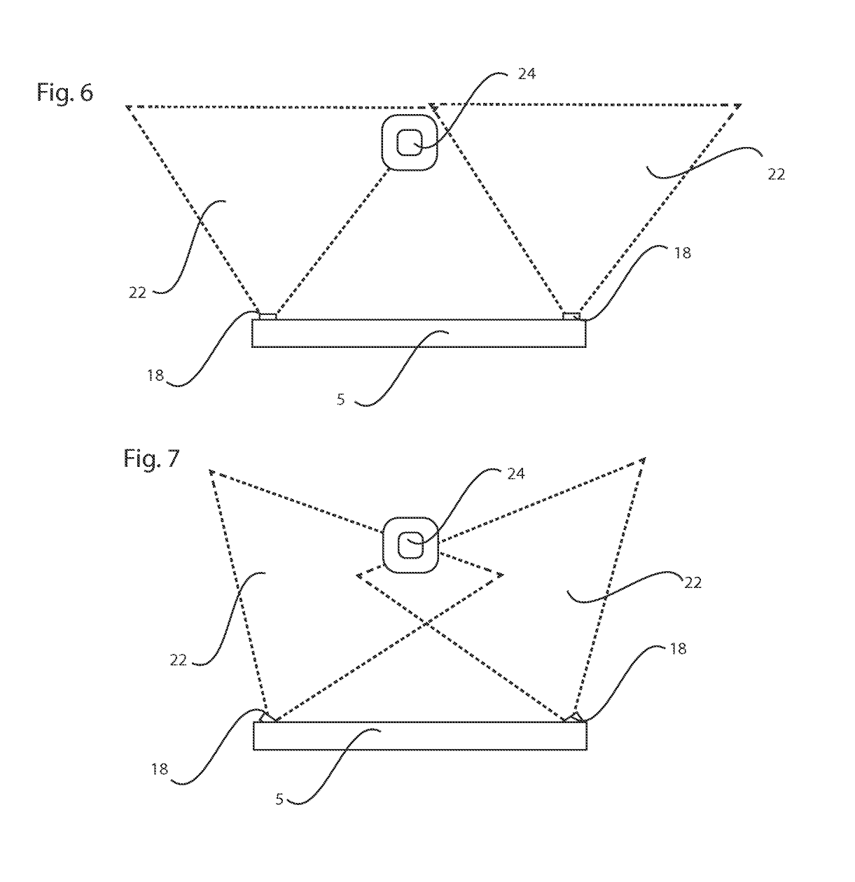

Referring to FIGS. 6, 7 and 8, the Transparent LCD window with adjustable spot lights (5) placed in front of a sample showcased product (24) in a horizontal position, seen from the top, with its Vertical adjustable LED panels (18) facing front illuminating an area (22), in FIG. 6, the adjustable LED panels (18) are deployed directly to the front not illuminating completely right the sample showcased product (24) not creating enough illumination so the transparent LCD screen (13) does not display the colors brighter. In FIG. 7, the adjustable LED panels (18) are deployed in an angle to the inside illuminating completely right the sample showcased product (24), creating the brightness behind the transparent LCD screen (13) optimum for the transparent LCD screen (13) to display the colors and images clear.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A transparent LCD window frame with adjustable spot LED lights comprising:
an all inclusive frame with a window.

2. the back side of the frame from claim 1 to have more than one circumvent adjustable LED spot lights strips.
